(19) United States
(12) Patent Application Publication
(10) Pub. No.: US 2026/0214331 A1
(43) Pub. Date: Jul. 23, 2026

(54) DIGITAL IMAGE ENCODING METHOD USING VARIABLE QUANTIZATION COEFFICIENT

(71) Applicant: HANWHA VISION CO., LTD., Seongnam-si (KR)

(72) Inventors: Seungwon PARK, Seongnam-si (KR); Dongjin Park, Seongnam-si (KR); Daebong Kim, Seongnam-si (KR); Youngsang Kwon, Seongnam-si (KR)

(73) Assignee: HANWHA VISION CO., LTD., Seongnam-si (KR)

(21) Appl. No.: 19/646,001

(22) Filed: Apr. 13, 2026

Related U.S. Application Data
(63) Continuation of application No. PCT/KR2024/013574, filed on Sep. 9, 2024.

(30) Foreign Application Priority Data
Oct. 26, 2023 (KR) 10-2023-0144338

(51) Int. Cl. H04N 23/68; H04N 19/124; H04N 19/167; H04N 23/69

(52) U.S. Cl. CPC H04N 23/6811; H04N 19/124; H04N 19/167; H04N 23/6812; H04N 23/69

(57) ABSTRACT

A digital image encoding method using a variable quantization parameter includes: acquiring vibration information about a camera from a sensor; determining a common region and a non-common region between a reference frame of the camera and a current frame of the camera caused by vibration based on determining, on the basis of the vibration information, that effective vibration has occurred; and applying a larger quantization parameter to encoding of the non-common region than the common region, wherein the effective vibration comprises vibration that satisfies a predetermined condition.

### CROSS-REFERENCE TO RELATED APPLICATION

This application is a bypass continuation application of International Application No. PCT/KR2024/013574, filed on Sep. 9, 2024, in the Korean Intellectual Property Receiving Office, which is based on and claims priority to Korean Patent Application No. 10-2023-0144338, filed on Oct. 26, 2023, in the Korean Intellectual Property Office, the disclosures of which are incorporated herein in their entireties by reference.

### BACKGROUND

Embodiment of the present disclosure relate to encoding a digital image and, more particularly, to encoding a digital image applying a variable quantization coefficient or parameter that considers vibration and/or shock.

As surveillance and security systems are widely used, the number of various image acquisition devices including surveillance cameras is increasing. Due to the increase in the image acquisition devices, for example, cameras, and expansion of the use of pan-tilt-zoom (PTZ) cameras, blind spots are reduced, and accordingly, both the positive function represented by improvement in the effectiveness of crime and accident prevention and the utility for military and security purposes are increasing.

However, surveillance cameras used in outdoor surveillance systems for crime prevention, public security, or military purposes are often installed not only on solid structures such as walls and ceilings, but also in locations without buildings, such as on poles that are sensitive to external impact, in order to secure a wide field of view. This causes, depending on wind or various vibration or impact factors, a camera to be directed toward a direction other than the direction intended by a user for a long time, and results in valuable computing resources being wasted on processing images of regions of low importance in images acquired by the camera.

### SUMMARY

The present disclosure enables computing resources to be efficiently utilized in an image processing system by saving resources when encoding regions not intended by a user among captured image frames when impact or vibration occurs in a camera.

The objectives of the present disclosure are not limited to the objectives described above and other objectives will be clearly understood by those skilled in the art from the following description.

The present disclosure provides a digital image encoding method using a variable quantization coefficient or parameter (hereinafter “parameter”).

According to an aspect of the present disclosure, the encoding method may include: acquiring vibration information about a camera from a sensor; determining a common region and a non-common region between a reference frame of the camera and a current frame of the camera caused by vibration based on determining, on the basis of the vibration information, that effective vibration has occurred; and applying a larger quantization parameter to encoding of the non-common region than the common region, wherein the effective vibration comprises vibration that satisfies a predetermined condition.

The predetermined condition comprises: (i) a magnitude of the vibration included in the vibration information being greater than or equal to a predetermined magnitude, (ii) a frequency of occurrence of the vibration included in the vibration information being less than or equal to a predetermined frequency, or (iii) the magnitude of the vibration included in the vibration information being greater than or equal to the predetermined magnitude and the frequency of occurrence of the vibration included in the vibration information being less than or equal to the predetermined frequency.

The method may further include determining a magnitude of the vibration based on the vibration information, prior to the applying the larger quantization parameter, wherein a quantization parameter to be applied to the encoding of the non-common region is increased in proportion to the magnitude of the vibration.

The sensor may include at least one of a gyro sensor and an accelerometer.

The sensor may be embedded in the camera.

The applying the larger quantization parameter may include changing a difference between a quantization parameter that is applied to the encoding of the non-common region and a quantization parameter that is applied to encoding of the common region on the basis of distribution of a magnitude and a frequency of the effective vibration.

The method may further include determining whether a magnitude of vibration determined as the effective vibration exceeds a maximum value which is predetermined, prior to the determining the common region and the non-common region, wherein the determining the common region and the non-common region is performed based on the magnitude of the vibration determined as the effective vibration not exceeding the maximum value, and based on the magnitude of the vibration determined as the effective vibration exceeding the maximum value, an encoding method of the current frame is changed in accordance with a duration of the vibration of which the magnitude exceeds the maximum value.

The maximum value of the magnitude of the vibration determined as the effective vibration is a value corresponding to a displacement that causes common region of a frame, which is represented when the reference frame of the camera is zoomed in by 1.5 to 2 times, and the current frame caused by the vibration to become a minimum area which is predetermined.

Based on the duration of the vibration of which the magnitude exceeds the maximum value not persisting for the predetermined time or longer, a present maximum quantization parameter may be applied to the current frame or information of the effective vibration is ignored.

The method may further include stopping the applying the larger quantization parameter to the encoding of the non-common region based on an object of interest being detected in the non-common region, after the determining the common region and the non-common region.

As an aspect of the present disclosure, a non-transitory computer-readable recording medium storing a computer-executable program including instructions for performing the digital image encoding method described above may be provided.

According to embodiments disclosed in the present specification, there is an effect of providing resources required for encoding a region deviating from an original frame among captured digital image frames due to shaking.

Further, according to embodiments disclosed herein, only when a camera shakes greatly beyond a threshold value, a quantization parameter is optionally and adaptively varied, so there is an effect of continuously showing a frame at a high resolution in a case of small vibration or shock that does not greatly change an angle of view, and of optionally saving encoding resources only when large vibration that makes high-resolution encoding meaningless occurs.

Meanwhile, the effects of the present disclosure are not limited to the effects described above and other effects can be clearly understood by those skilled in the art from the following description.

### BRIEF DESCRIPTION OF DRAWINGS

The accompanying drawings of the present disclosure exemplify various embodiments and help easy understanding of the present disclosure together with the detailed description for implementing the present disclosure, so the present disclosure should not be construed as being limited to the matters described in the drawings.

FIG. 1 is a schematic diagram illustrating a network configuration of a surveillance camera system according to an embodiment of the present disclosure.

FIG. 2 is an example of a configuration diagram of a surveillance camera according to an embodiment of the present disclosure.

FIG. 3 illustrates an outdoor space and an image frame representing a capturing region of a surveillance camera.

FIGS. 4 and 5 illustrate, by way of example, changes in an image frame when a surveillance camera is shaken.

FIG. 6 illustrates example criteria for controlling in detail a variation amount of a quantization parameter in a digital image encoding method according to an embodiment of the present disclosure in consideration of the magnitude and frequency of vibration or shock.

FIGS. 7 and 8 illustrate, by way of example, changes in an image frame according to the magnitude of vibration or shock applied to a surveillance camera.

FIG. 9 illustrates a common region and a non-common region of an image frame according to the magnitude of vibration or shock applied to a surveillance camera.

FIG. 10 illustrates a common region and a non-common region reflecting displacement of the image frame according to relatively very large vibration or shock in FIG. 9.

FIG. 11 is a flowchart of a digital image encoding method according to an embodiment of the present disclosure.

### DETAILED DESCRIPTION

The embodiments disclosed in the present disclosure can be applied to surveillance cameras and related systems. However, the present disclosure is not limited thereto, and may also be applied to all devices and methods to which the technical spirit of the present disclosure can be applied.

Hereinafter, embodiments of the present disclosure will be described in detail with reference to the accompanying drawings and the same or similar components are given the same reference numerals regardless of the numbers of figures and are not repeatedly described.

The embodiments described herein are non-limiting example embodiments, and thus, the disclosure is not limited thereto and may be realized in various other forms. Each of the embodiments provided herein is not excluded from being associated with one or more features of another example or another embodiment also provided herein or not provided herein but consistent with the disclosure.

As used herein, expressions “at least one of a, b, and c,” “at least one of a, b, or c,” and “a, b, and/or c” should be understood as including only a, only b, only c, both a and b, both a and c, both b and c, or all of a, b, and c.

As used herein, the term “image” is interchangeably or collectively used for both a still image and a moving picture. In addition, vibration or shock may be used interchangeably as necessary while shock is defined as falling within vibration, and tremor or similar concepts are defined as falling within vibration.

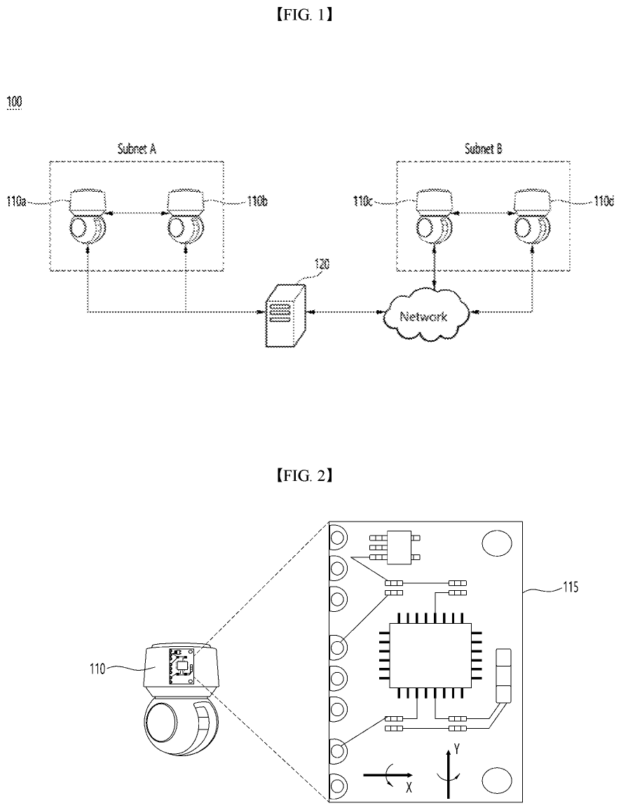

FIG. 1 is a schematic diagram illustrating a network configuration of a surveillance camera system 100 according to an embodiment of the present disclosure. Referring to FIG. 1, cameras 110a, 110b, 110c, and 110d are connected to a network to transmit and receive data with one another, or may be connected to, for example, a server 120 that controls the surveillance camera system 100. The cameras 110a, 110b, 110c, and 110d may each be directly connected to the server 120 or may be connected via a network depending on circumstances. The network disclosed in the present disclosure may be, for example, a wireless network, a wired network, a public network such as the Internet, a private network, a Global System for Mobile Communications (GSM) network, a General Packet Radio Network (GPRN), a Local Area Network (LAN), a Wide Area Network (WAN), a Metropolitan Area Network (MAN), a cellular network, a Public Switched Telephone Network (PSTN), a Personal Area Network, Bluetooth, Wi-Fi Direct, Near Field Communication, Ultra-Wide Band, a combination thereof, or any other network, but is not limited thereto. In the network, the cameras 110a, 110b, 110c, and 110d may belong to a same subnet or to different subnets. The camera 110a and the camera 110b, or the camera 110c and the camera 110d, belonging to a same subnet, may be optionally or alternatively directly connected, or may be connected through another network path.

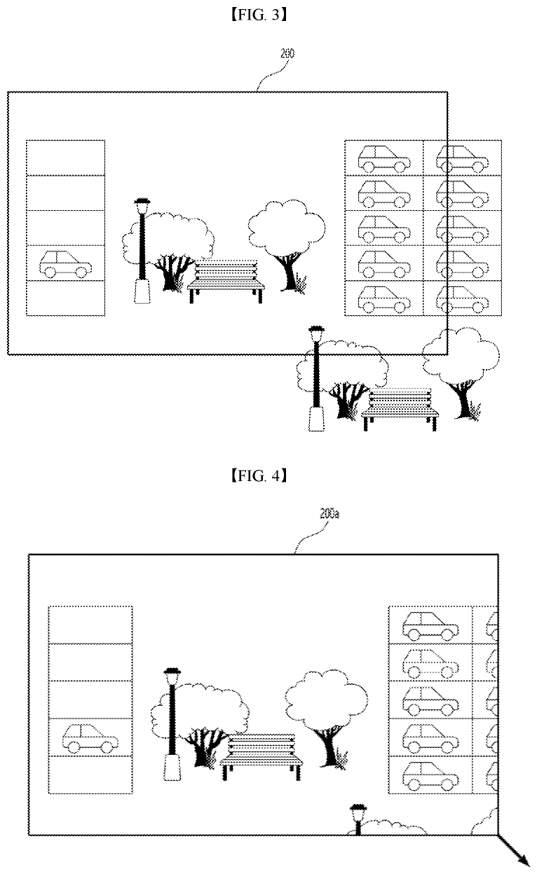

FIG. 2 illustrates an embodiment of a camera 110 which may be any one of the cameras 110a, 110b, 110c, and 110d shown in FIG. 1. The camera 110 may be, for example, a general fixed closed-circuit television (CCTV) camera or a pan-tilt-zoom (PTZ) camera with a variable angle of view. For example, the camera 110 may include a sensor 115 including at least one of a gyro sensor and an accelerometer. A gyro sensor, which detects angular velocity, measures a Coriolis force acting in a direction orthogonal to a direction of velocity when an object rotates, and converts it into an electrical signal. Meanwhile, an accelerometer, which measures how much force an object is receiving on the basis of the Earth's gravitational acceleration, is widely used to determine vibration or a degree of tilt of an object. The sensor 115 is shown in FIG. 2 as being included in the camera 110, but is not limited thereto and may provide information related to rotation or movement of the camera 110 through a separate external sensor 115. Information related to vibration and/or shock sensed by the sensor 115 may be transmitted, for example, to the server 120 that can process, transmit, and receive images acquired from the camera 110 on the network of FIG. 1.

FIG. 3 illustrates an image frame 200 captured by the camera 110 installed to capture a specific region in accordance with an embodiment of the present disclosure, together with a scene outside the frame 200. Except in specific cases where 360-degree capture is possible, the camera 110 generally captures a region and converts it into an electrical signal, and the electrical signal may be encoded for the region of the image frame 200 by, for example, a digital encoder. Due to the limitation of an angle of view of the camera 110, the region that is captured by a camera 110 may be displayed, for example, as a rectangular frame 200 as illustrated in FIG. 2. Accordingly, in FIG. 3, portions of subjects (trees, a streetlight, and a parking lot) extending beyond the frame 200 are not captured by the camera 110, and only the region included in the frame 200 is converted into an electrical signal and encoded.

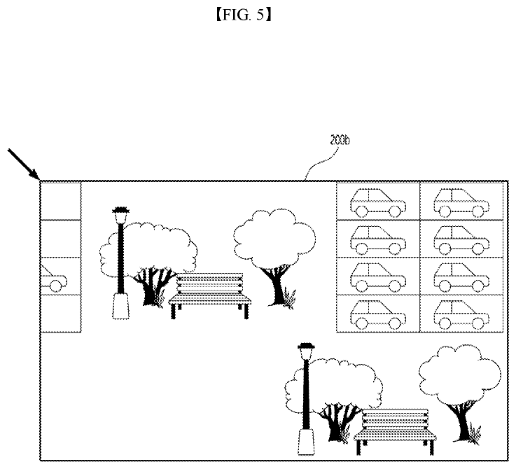

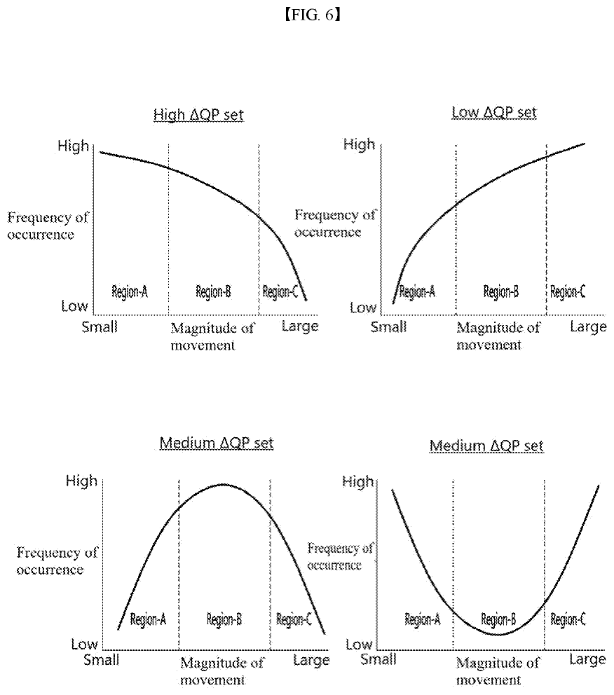

FIGS. 4 and 5 illustrate, by way of example, changes in an image frame when the camera 110 is shaken. For example, FIG. 4 illustrates a frame 200a that is actually converted into an electrical signal and encoded by the camera 110 of FIG. 2 when no shock or vibration is applied to the camera 110. Here, for example, it is assumed that a viewing direction of the camera 110 shifts toward the lower right as indicated by an arrow due to shock or vibration. FIG. 5 illustrates a frame 200b that is captured by the camera 110 when shock or vibration is applied. As the frame 200b moves from the upper left as indicated by an arrow in FIG. 5, a portion of the scene that was not captured in frame 200a of FIG. 4 (portions of the trees, the bench, the streetlight, and the parking lot at the lower right) appears, whereas a portion of the scene on the left (the parking lot) and a portion of the scene at the upper right (the parking lot) are not captured. Here, even if the camera 110 is shaken by shock or vibration and the viewing direction partially changes, there remains a region that is still common, whereas regions that were not present in the previous frame 200a appear in the frame 200b. However, since an intention of a user of the system 100 is that the region of the existing frame 200a is a primary region of interest (ROI), it is not efficient to encode a non-region of interest (non-ROI), which is a region appearing only in the frame 200b, using the same computing resources as those for the ROI. Further, since some reduction in resolution of the non-ROI is tolerable, a bitrate can be reduced. As described above, for example, by applying a larger quantization parameter (QP) to the non-ROI, a bitrate for the non-ROI can be reduced.

Meanwhile, the sensor 115 illustrated in FIG. 2 transmits information regarding movement of the camera 110 intermittently or continuously. Here, when the sensor 115 is installed outdoors (for example, on a wire fence, a pole, or an outer wall), rather than on a fixed indoor wall, a sensing value obtained by the sensor 115 may continuously fluctuate due to wind or passing nearby vehicles. Therefore, determining that shock or vibration is present whenever the sensing value of the sensor 115 changes, and determining a common region and a non-common region of the frames 200a and 200b, may rather cause inefficiency in an operation of the system 100. For example, in a case of minor vibration due to vehicle traffic, transmitting the region of the shifted frame 200b as it is does not cause a problem. Therefore, it is desirable to determine a non-common region and a common region and apply different quantization parameters (or quantization parameter values) only when shock or vibration of a predetermined magnitude or greater actually occurs.

According to an embodiment of the present disclosure, vibration is determined to have a predetermined magnitude or greater when it is equal to or greater than a threshold value Th within a range between a minimum value (min) and a maximum value (max) of sensing values output from the sensor 115 during a predetermined period. The threshold value Th may be determined as a value that is set by a user of the system 100 or that is variable depending on the setting environment of the camera 110. In an embodiment, when sensing values of the sensor 115 output in accordance with shaking during an operation of the camera 110 are recorded for a predetermined period, a value that is 70% or more of an interval between the minimum value (min) and the maximum value (max) from the minimum value (min) may be set as the threshold value Th. Here, the predetermined period is a value that may be set by a user of the system 100, and may be set, for example, to one day, one week, or one month. Alternatively, it may be a period during which a function for considering vibration or shock according to a sensing value is enabled.

If a sensing value of the sensor 115 is less than the threshold value Th, the magnitude of vibration or shock is determined to be minor, and a quantization parameter is not variably applied. On the other hand, if the sensing value is equal to or greater than the threshold value Th, it is determined that effective vibration and/or shock has occurred, and the quantization parameter may be variably applied by distinguishing a common region and a non-common region between a reference frame set by a user and a current frame (caused by vibration or shock). Depending on the magnitude of vibration or shock and, selectively or alternatively, when a count of vibrations and shocks during the predetermined period is equal to or less than a predetermined value, that is, when the frequency is low, it may be determined that effective vibration or shock has occurred. Here, the predetermined value may be set by a user. For example, only when shock or vibration occurs at or below a predetermined frequency, it is determined that effective vibration has occurred, and the quantization parameter is variably applied by distinguishing a common region and a non-common region between a reference frame set by a user and a current frame (caused by vibration or shock). For example, when the frequency of occurrence of vibration or shock is high and a non-common region is frequently captured and processed in the system 100, it may be desirable not to increase the quantization parameter and to continuously process the non-common region at a high bitrate as in the common region.

As another embodiment, image encoding may be performed such that the quantization parameter of a non-common region is increased only when the magnitude of vibration or shock is equal to or greater than a predetermined magnitude (e.g., the sensing value of the sensor 115 is greater than or equal to the threshold value Th) and the frequency of the vibration or shock is equal to or less than a predetermined value. In this case, since not only the magnitude of shock or vibration but also the frequency is considered, it may be suitable for an encoding process in a specific situation. For example, when large vibration or shock persists for a long time (that is, when the frequency is high), since the frames 200a and 200b continuously change, the processing of separating a common region and a non-common region and applying different quantization parameters to the common region and the non-common region may become excessive, which may result in inefficient resource utilization for encoding. In addition, when the frequency is high, large continuous vibration occurs for a long time as in an earthquake, so a common region before and after the vibration may not be generated.

Meanwhile, when setting a larger quantization parameter to be applied to a frame determined to have shaking in consideration of a condition of a frequency of occurrence and/or a magnitude of vibration or shock (e.g., the sensing value of the sensor 115), a difference ΔQP between a quantization parameter that is applied to a frame determined to have shaking that satisfies the condition and a quantization parameter that is applied to a frame determined to have shaking that does not satisfy the condition may be fixed, but it is also possible to set the difference ΔQP more flexibly and in greater detail in accordance with a pattern between the magnitude and the frequency of occurrence of vibration or shock.

Referring to FIG. 6, for example, as in a pattern shown in the upper left, when the frequency of occurrence of a small magnitude vibration or shock (collectively “movement”) is high while the occurrence of vibration or shock that causes substantial shaking is rare, a bitrate required for a relatively small number of frames determined to have substantial shaking is significantly reduced by increasing the difference ΔQP, whereby it is possible to greatly reduce an image quality of a frame having a low frequency. On the other hand, when a pattern in the upper right is exhibited in which the frequency of occurrence of large magnitude vibration or shock is high and the frequency of occurrence of small magnitude vibration or shock is low, encoding may be performed such that a predetermined level of bitrate is allocated even to a frame having substantial shaking by setting the difference ΔQP to a small value. This prevents a problem that when a large difference ΔQP is applied to frames with large shock or vibration, the image quality of multiple frames decreases, so the captured moving image cannot be recognized. Further, when the magnitude and the frequency of occurrence of vibration or shock exhibit patterns such as those in the lower portion of FIG. 6, the difference ΔQP may be set to an intermediate value between the values of the previous two examples (upper left and upper right).

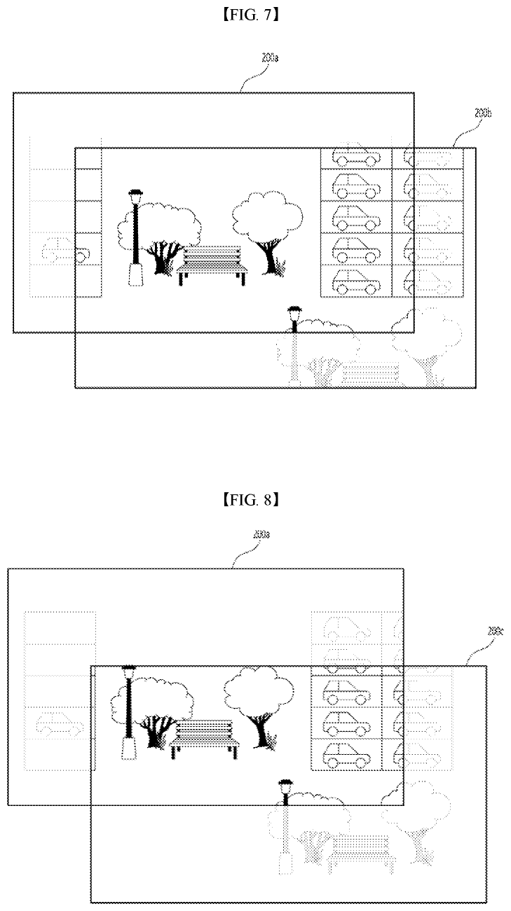

Meanwhile, according to an embodiment of the present disclosure, in addition to differentially applying quantization parameters between a common region and a non-common region as described above, quantization parameters may be differentially applied even between non-common regions distinguished in accordance with the magnitude of vibration or shock. Hereinafter, different application of quantization parameters in proportion to the magnitude of shock or vibration between non-common regions is described with reference to FIG. 7 and FIG. 8.

FIG. 7 illustrates a case in which shock or vibration applied to the camera 110 is small. Here, a frame 200a is an original frame 200a set by a user, and a frame when relatively small vibration or shock is applied is a frame 200b. Meanwhile, FIG. 8 illustrates a change in frames before and after relatively large vibration or shock is applied. The frame 200a of FIG. 8 is the same as described with respect to FIG. 7, and because the magnitude of vibration or shock is large, a frame 200c has a greater displacement from the frame 200a than the frame 200b has. Accordingly, it can be seen that a common region in FIG. 8 is smaller in area a common region in FIG. 7.

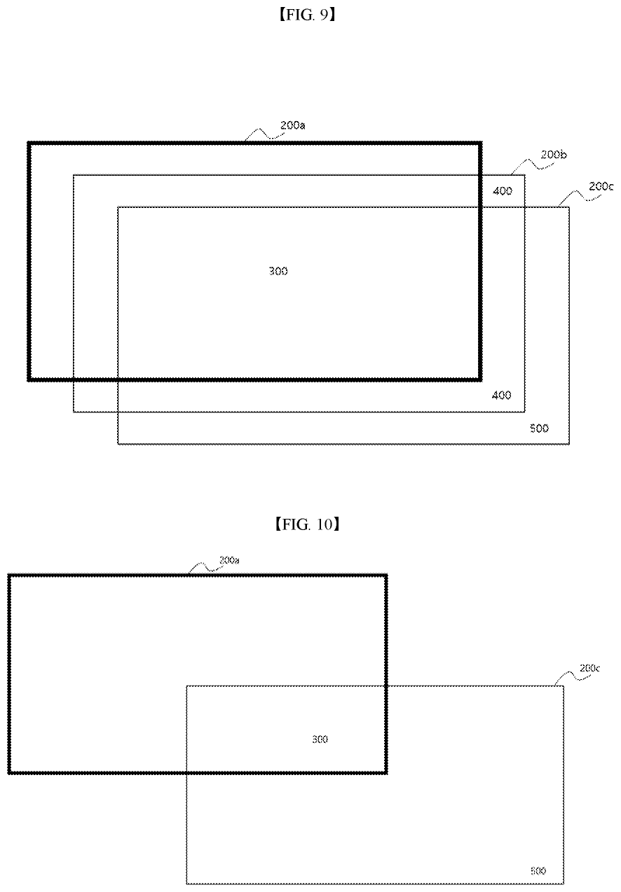

The frames according to the magnitude of vibration or shock shown in FIGS. 7 and 8 are illustrated in an overlapping manner in FIG. 9. Referring to FIG. 9, the frame 200a before vibration or shock, the frame 200b when relatively small vibration or shock occurs, and the frame 200c when relatively large vibration or shock occurs are shown in an overlapping manner. Here, a region that is common to the frames 200a to 200c is a common region 300, and there exist a non-common region 400 added in the frame 200b when vibration or shock is small and a non-common region 500 added in the frame 200c when vibration/shock is large. Here, the non-common region 400 partially overlaps the non-common region 500. In this case, a bitrate that is used for encoding when shock or vibration is large is reduced by applying a larger quantization parameter to the non-common region 500 than the quantization parameter that is applied to the non-common region 400, whereby encoding of the portion of a non-ROI of the intermittently moving frame 200c can be efficiently performed.

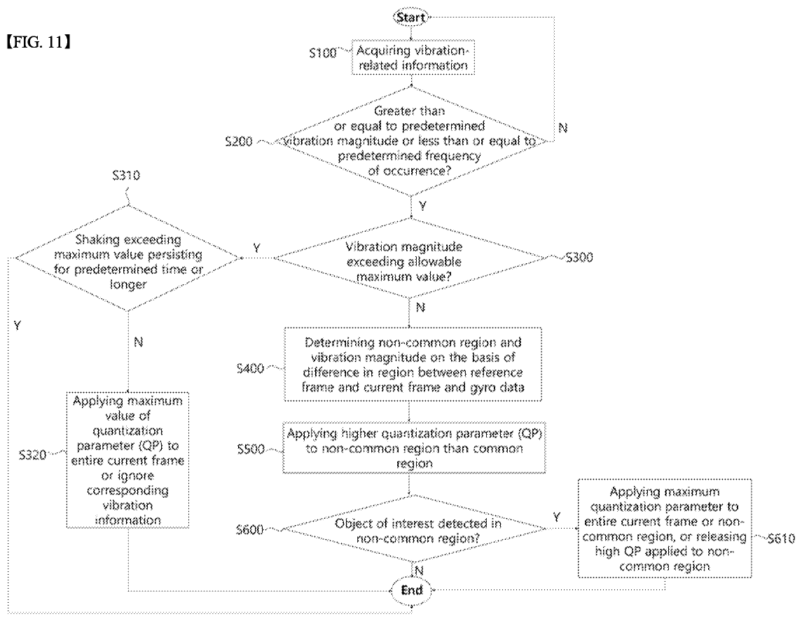

FIG. 10 illustrates a common region and a non-common region reflecting displacement of an image frame when vibration or shock becomes relatively very large in FIG. 9. As described above, according to the present disclosure, it may be determined that shock or vibration has actually occurred only when shock or vibration with a magnitude exceeding a predetermined magnitude (e.g., the threshold value Th) and a frequency equal to or less than a predetermined value occurs, instead of small and frequent vibration or shock. However, when shock or vibration becomes greater than or equal to a maximum allowable magnitude, which may be set by a user, the camera 110 shown in FIGS. 1 to 2 excessively deviates from a region intended to be captured, and in this case, in FIG. 10, a common region 300 includes only a very small portion of a frame 200a originally intended to be captured by the camera 110. Accordingly, when shock or vibration of a magnitude that deviates from the predetermined value occurs, as described above, it may be meaningless to encode a frame 200c captured by the camera 110 shaken by vibration or shock. Therefore, according to the present disclosure, by setting a minimum value of a size ratio of a common region 300, that is, a maximum limit of displacement of a variable region, when shaking of the camera 110 by shock or vibration exceeds a maximum limit, an even larger quantization parameter, for example, a maximum quantization parameter provided by a codec of an encoder, may be applied to the frame 200c for encoding. Here, the maximum limit of displacement may be set on the basis of the size of the frame 200a that is shown when the common region 300 between the frame 200c and the frame 200a is zoomed in, for example, by 1.5 times or 2 times with respect to the original frame 200a.

Meanwhile, depending on a user setting, it may be possible to ignore the sensing value of vibration or shock and perform encoding according to the present disclosure, instead of determining that the shock or vibration is excessive and applying a large quantization parameter. Further, when vibration or shock exceeding the maximum limit of displacement of a variable region persists for a predetermined time or longer, it may be determined that there is a problem in an installation environment of the camera 110, and control of a quantization parameter according to the present disclosure may not be applied.

FIG. 11 illustrates a flowchart of a digital image encoding method according to an embodiment of the present disclosure. The method begins by acquiring vibration-related (or shock-related) information (data) from the sensor 115 (S100). On the basis of the acquired information, if the magnitude of vibration (or shock) is less than a predetermined magnitude (e.g., the threshold value Th) or the frequency of vibration is less than or equal to a predetermined count, the method returns to step S100 and acquires vibration-related information again, and if it is determined otherwise (S200), the method proceeds to step S300.

In step S300, the method sets, as a maximum allowable value corresponding to a maximum allowable magnitude of vibration, for example, a displacement that causes a common region of a frame, which is represented when the frame intended to be captured by the camera 110 is zoomed in, for example, within a range of 1.5 to 2 times, and a frame displaced by vibration to become a minimum area, and determines whether the maximum allowable value is exceeded. Here, the maximum allowable value of the displacement and the minimum area may be predetermined by a user setting.

If a magnitude of the displacement exceeds the maximum allowable value, it is determined whether the excessive vibration that causes the displacement persists for a predetermined time or longer (S310). If the excessive vibration does not persist for the predetermined time, the method performs encoding by applying a quantization parameter, for example, a maximum value, to the entire frame that is currently encoded, or performs encoding in accordance with a setting while ignoring the corresponding vibration information (S320), and then the method is terminated. In step S310, if the excessive vibration persists for more than predetermined time, the method is terminated, and it is possible to determine that there is a problem in the installation environment of the camera 110 and take appropriate measures including not applying quantization parameter control according to the present disclosure. In step S300, if the vibration magnitude does not exceed the maximum allowable value, the method proceeds to step S400, and determines a difference in region between a reference image frame set by a user and a current frame changed by vibration/shock, and also determines the magnitude of vibration on the basis a sensing value of the sensor 115. Thereafter, the method applies a small quantization parameter to encoding of a common region and applies a larger quantization parameter to a non-common region (S500).

The method may optionally or alternatively proceed to step S600. For example, an event in which an object of interest can be detected in a non-common region may occur. In this case, application of a maximum quantization parameter to the entire current frame or to the non-common region is released or stopped, or application of a high quantization parameter only to the non-common region is released or stopped so that a lower quantization parameter is applied to the non-common region or the current frame (that is, a higher bitrate is allocated), whereby it is possible to improve image quality during encoding (S610). For convenience of description, although steps S600 and S610 are illustrated and described as being performed after the step of applying different quantization parameter between a non-common region and a common region, optionally or alternatively, steps S600 and S610 may be performed before step S600. Thereafter, the method is terminated.

In the above description, depending on embodiments of the present disclosure, the steps, processes, or operations may be further divided into additional steps, processes, or operations, or may be combined into fewer steps, processes, or operations. Further, some steps, processes, or operations may be omitted as necessary, and the order of the steps, processes, or operations may be changed.

At least some of the devices (e.g., modules or the functions) or methods (e.g., operations) according to the above embodiments may be configured, for example, by instructions stored in a computer-readable storage medium in the form of a program module. When the instructions are executed by one or more processors, the processor can perform the functions corresponding to the instructions. The computer-readable storage medium 1020 may include all kinds of recording devices that keep data that can be read by a computer system. The computer-readable storage medium may include a hard disk, a floppy disk, a magnetic medium (e.g., magnetic tape), an optical medium (e.g., compact disc read-only memory (CD-ROM), digital versatile disc (DVD)), a magneto-optical medium (e.g., floptical disk), a hardware device (e.g., read-only memory (ROM), random access memory (RAM), or flash memory), and may also include one implemented in the form of a carrier wave (for example, transmission via the Internet). Further, program commands may include not only machine languages generated by a compiler, but also high-level language codes that can be executed by a computer using an interpreter, etc. The hardware device may be configured to operate as one or more software modules to perform the operation of various embodiments, and vice versa.

Modules or program modules according to various embodiments may include at least one or more of the components described above, may be partially omitted, or may further include additional other components. Operations that are performed by modules, program modules, or other components according to various embodiments may be performed sequentially, in parallel, repeatedly, or heuristically. Further, some operations may be performed in other orders or omitted, or other operations may be added.

Further, those skilled in the art will recognize that the boundaries between the functionalities of the foregoing operations are merely illustrative. Multiple operations may be combined into a single operation, a single operation may be divided into additional operations, and operations may be executed to at least partially overlap in time. Further, alternative embodiments may include multiple instances of a particular operation, and the order of the operations may be changed in various embodiments. However, other modifications, variations, and alternatives are also possible. Accordingly, the detailed description and the drawings should be regarded as illustrative rather than restrictive.

Further, for example, the examples described above, or a portion thereof, may be implemented as a physical circuit or a software or code representation of a logical expression that can be converted into a physical circuit, for example, using any suitable type of hardware description language.

Example embodiments of the technology of the present specification have been described above with reference to the accompanying drawings. Herein, the terms and expressions used in the present disclosure and the claims should not be construed as being limited to their ordinary or dictionary meanings but should be construed in accordance with the technical spirit of the present disclosure. The scope of the present disclosure is not limited to the embodiments disclosed herein, and the present disclosure may be modified, altered, or improved in various forms within the spirit of the present disclosure and the scope of the appended claims.

What is claimed is:

1. A digital image encoding method using a variable quantization parameter, comprising:
acquiring vibration information about a camera from a sensor;
determining a common region and a non-common region between a reference frame of the camera and a current frame of the camera caused by vibration based on determining, on the basis of the vibration information, that effective vibration has occurred; and
applying a larger quantization parameter to encoding of the non-common region than the common region,
wherein the effective vibration comprises vibration that satisfies a predetermined condition.

2. The digital image encoding method of claim 1, wherein the predetermined condition comprises:
(i) a magnitude of the vibration included in the vibration information being greater than or equal to a predetermined magnitude,
(ii) a frequency of occurrence of the vibration included in the vibration information being less than or equal to a predetermined frequency, or
(iii) the magnitude of the vibration included in the vibration information being greater than or equal to the predetermined magnitude and the frequency of occurrence of the vibration included in the vibration information being less than or equal to the predetermined frequency.

3. The digital image encoding method of claim 1, further comprising determining a magnitude of the vibration based on the vibration information, prior to the applying the larger quantization parameter,
wherein a quantization parameter to be applied to the encoding of the non-common region is increased in proportion to the magnitude of the vibration.

4. The digital image encoding method of claim 1, wherein the sensor comprises at least one of a gyro sensor and an accelerometer.

5. The digital image encoding method of claim 4, wherein the sensor is included in the camera.

6. The digital image encoding method of claim 2, wherein the applying the larger quantization parameter comprises changing a difference between a quantization parameter that is applied to the encoding of the non-common region and a quantization parameter that is applied to encoding of the common region on the basis of distribution of a magnitude and a frequency of the effective vibration.

7. The digital image encoding method of claim 1, further comprising determining whether a magnitude of vibration determined as the effective vibration exceeds a maximum value which is predetermined, prior to the determining the common region and the non-common region,
wherein the determining the common region and the non-common region is performed based on the magnitude of the vibration determined as the effective vibration not exceeding the maximum value, and
wherein based on the magnitude of the vibration determined as the effective vibration exceeding the maximum value, an encoding method of the current frame is changed in accordance with a duration of the vibration of which the magnitude exceeds the maximum value.

8. The digital image encoding method of claim 7, wherein the maximum value of the magnitude of the vibration determined as the effective vibration is a value corresponding to a displacement that causes common region of a frame, which is represented when the reference frame of the camera is zoomed in by 1.5 to 2 times, and the current frame caused by the vibration to become a minimum area which is predetermined.

9. The digital image encoding method of claim 7, wherein
based on the duration of the vibration of which the magnitude exceeds the maximum value not persisting for a predetermined time or longer, a present maximum quantization parameter is applied to the current frame or information of the effective vibration is ignored.

10. The digital image encoding method of claim 1, further comprising stopping the applying the larger quantization parameter to the encoding of the non-common region based on an object of interest being detected in the non-common region, after the determining the common region and the non-common region.

11. A non-transitory computer-readable recording medium storing a computer-executable program including instructions for performing the digital image encoding method of claim 1.
